(19) United States
(12) Patent Application Publication
(10) Pub. No.: US 2023/0264534 A1
(43) Pub. Date: Aug. 24, 2023

(54) SPRING PAD FOR A SUSPENSION

(71) Applicants: HYUNDAI MOTOR COMPANY, Seoul (KR); KIA CORPORATION, Seoul (KR); DMC, INC, Seongnam-si (KR)

(72) Inventors: Ga Ram Bark, Hwaseong-si (KR); Byeong Gu Jang, Yeongcheon-si (KR)

(73) Assignees: HYUNDAI MOTOR COMPANY, Seoul (KR); KIA CORPORATION, Seoul (KR); DMC, INC, Seongnam-si (KR)

(21) Appl. No.: 17/881,715

(22) Filed: Aug. 5, 2022

(30) Foreign Application Priority Data
Feb. 18, 2022 (KR) 10-2022-0021529

(51) Int. Cl. B60G 11/52

(52) U.S. Cl. CPC B60G 11/52; B60G 2204/124

(57) ABSTRACT

A spring pad for a suspension can satisfy both conflicting dynamic seating property and durability, and unification of specifications. In particular, the spring pad may include: a body portion disposed on one side of a spring to support the spring; and an insert portion embedded inside of the body portion and integrally formed with the body portion. The spring is seated on an inclined surface of the body portion, and the inclined surface may be formed in a spiral shape gradually increasing in height. A spiral curve of the inclined surface may be formed by reflecting a composite line minimizing a gap between the inclined surface and the spring.

### CROSS-REFERENCE TO RELATED APPLICATION (S)

This application claims priority to and the benefit of Korean Patent Application No. 10-2022-0021529, filed on Feb. 18, 2022 in the Korean Intellectual Property Office, the disclosure of which is incorporated herein by reference in its entirety.

### TECHNICAL FIELD

The present disclosure relates to a spring pad for a suspension capable of satisfying requirements for both dynamic seating property and durability, and unification of specification.

### BACKGROUND

The statements in this section merely provide background information related to the present disclosure and may not constitute prior art.

A spring pad is a cushioning and supporting member for a spring mounted between a vehicle body and a suspension. Such a spring pad, for example, avoids direct metal-to-metal contact between a lower arm and a spring, and strengthens unity to provide seating property of the spring.

For example, in a suspension, on both sides (i.e., left and right sides) of a rear wheel, since springs may be assembled symmetrically at the origin, it is difficult for commercial spring pads to equally satisfy the dynamic seating property of springs between the left and right sides of the rear wheel. In order to equally satisfy left-right dynamic seating property, it is desired to dualize the left-right spring pads separately, which may increase costs. For this reason, if the spring pads are uniformly united, there is a high possibility that either dynamic seating property on the left or right sides is insufficient.

In addition, since durability is a more important performance in a spring pad, based on analysis of durability performance and results of actual vehicle evaluation, the spring pad may inevitably be designed in a direction satisfying dynamic seating property, while taking the side exposed to greater impacts among the left and right as a standard.

### SUMMARY

The present disclosure provides a spring pad for a suspension that can satisfy both dynamic seating property and durability which are conflicting properties, as well as unification of specifications.

According to an aspect of the present disclosure, a spring pad may include: a body portion disposed on one side of a spring to support the spring; and an insert portion embedded inside of the body portion and integrally formed with the body portion. In particular, an inclined surface on which the spring is seated in the body portion is formed in a spiral shape gradually increasing in height, and a spiral curve of the inclined surface is formed by reflecting a composite line minimizing a gap between the inclined surface and the spring.

The body portion is formed of an elastic material, and the body portion may include: an interposition portion formed in a cylindrical shape to be inserted into the spring; a seating portion extending radially from one end portion of the interposition portion and on which the spring is seated; and a protruding step formed in the seating portion and to which one end of the spring is caught.

The protruding step may be formed to protrude in a height direction from the seating portion, and one side surface of the protruding step in a circumferential direction to which one end of the spring is caught may act as a starting point of the spring.

The inclined surface may be formed up to a section of up to 270° in a winding direction of the spring with a starting point of the spring as 0°.

When the spring pad is mounted on a suspension of a vehicle, the starting point of the spring may be mounted by being moved by 30 to 45° with respect to a longitudinal axis of the vehicle.

The composite line may be obtained by combining a reference line, a left side gap line regarding a gap between a spring pad having an inclined surface reflecting the reference line and a spring in a left-side suspension of a vehicle, and a right side gap line regarding a gap between a spring pad having an inclined surface reflecting the reference line and a spring in a right-side suspension of a vehicle, and connecting a maximum value of the gap at each azimuth in a winding direction of the spring from a starting point of the spring.

The reference line may include an initial reference line corresponding to a spiral of a lower end portion of the spring.

The insert portion is formed of a hard material, and the insert portion may include: an insert interposition portion embedded inside the interposition portion; an insert seating portion extending radially from one end portion of the insert interposition portion and embedded inside the seating portion; and an insert protruding step formed in the insert seating portion and embedded inside the protruding step.

An upper surface of the insert seating portion may include a concave portion formed to be recessed corresponding to a portion in which a thickness of an elastic material layer in the body portion is reduced.

A plurality of through-holes arranged in a circumferential direction may be formed in the insert seating portion, and a flat surface may be formed on an upper surface of the insert seating portion to surface-support the spring, and a groove portion may be formed by a rib surrounding each through-hole on an opposite side surface of the spring in the insert seating portion.

According to another aspect of the present disclosure, a spring pad may include: a body portion disposed on one side of a spring to support the spring; and an insert portion embedded inside the body portion and integrally formed with the body portion, wherein a plurality of through-holes arranged in a circumferential direction may be formed in the insert portion, a flat surface may be formed on one side surface of the insert portion to surface-support the spring, and a groove portion may be formed by a rib surrounding each through-hole on an opposite side of the spring in the insert portion.

The body portion is formed of an elastic material, and the insert portion may be formed of a hard material, and the insert portion may include: an insert interposition portion embedded inside an interposition portion inserted into the spring from the body portion; an insert seating portion extending radially from one end portion of the insert interposition portion; and an insert protruding step formed in the insert seating portion, wherein the plurality of through-holes may be formed in the insert seating portion.

### BRIEF DESCRIPTION OF DRAWINGS

The above and other aspects, features, and advantages of the present disclosure should be more clearly understood from the following detailed description, taken in conjunction with the accompanying lead-outs, in which:

FIG. 1 is a perspective view illustrating a state in which a spring pad according to an embodiment of the present disclosure supports a spring;

FIG. 2 is a perspective view of the spring pad shown in FIG. 1 as viewed from below;

FIGS. 3A and 3B are views for illustrating setting of a starting point of the spring in the spring pad;

FIG. 4 is a graph for explaining a composite line reflected in a spring pad according to an embodiment of the present disclosure;

FIG. 5 is a perspective view illustrating an insert portion inserted into the spring pad shown in FIG. 1;

FIG. 6 is a bottom view of the insert portion shown in FIG. 5;

FIG. 7 is a cross-sectional view of the insert portion shown in FIG. 5; and

FIG. 8 is a cross-sectional view illustrating an example in which a spring pad according to an embodiment of the present disclosure is applied to a lower arm.

The drawings described herein are for illustration purposes only and are not intended to limit the scope of the present disclosure in any way.

### DETAILED DESCRIPTION

Hereinafter, embodiments in the present disclosure are described with reference to the accompanying drawings. The disclosure may, however, be exemplified in many different forms and should not be construed as being limited to the specific embodiments set forth herein. Rather, these embodiments are provided to fully convey the scope of the present disclosure to those of having ordinary skill in the art. In the drawings, the same reference numerals are used throughout the present disclosure to designate the same or like elements, and the shapes and dimensions of elements may be exaggerated for clarity.

When a component, device, element, or the like of the present disclosure is described as having a purpose or performing an operation, function, or the like, the component, device, or element should be considered herein as being “configured to” meet that purpose or to perform that operation or function.

A suspension of a vehicle absorbs vibrations or shocks generated during driving while supporting a weight of a vehicle body, thereby mitigating vibrations or shocks transmitted to the vehicle body and a driver. The suspension is installed between the vehicle body and an axle, and may include at least one of an elastic member such as a coil spring, a leaf spring, a shock absorber, or the like.

For example, when a coil spring constituting a suspension is installed, in order to prevent shocks or noise from being generated as a coil spring made of metal is in direct contact with a support member of metal such as a lower arm, an axle, or the like, a spring pad made of an elastic material is disposed at an upper end or a lower end of the spring.

More specifically, when the spring moves from an empty vehicle state to a bump state, as a compression amount of the spring increases, reaction force of the spring increases in proportion to spring stiffness and operating displacement. When the reaction force is directly transmitted to the support member of metal without the spring pad, damage such as cracks and noise may be induced in the support member.

Conversely, when the spring operates from an empty vehicle state to a rebound state, reaction force of the spring may be reduced, and accordingly, there may be a problem in that the spring is outside of its original position or a position thereof is distorted. In addition, since a length of the spring is increased in the rebound state, foreign substances may be easily introduced thereto, which may lead to corrosion of components.

The spring pad may be interposed between a spring and a support member, such that direct contact between metal and metal may be avoided to prevent damage and noise, and unity between the spring and the support member may be strengthened to ensure seating property of the spring and prevent corrosion.

Such a spring pad should be designed to satisfy the dynamic seating property and durability. However, as described above, in a suspension on both sides, left and right sides of a rear wheel, the spring is assembled symmetrically to an origin, and the spring performs behaviors in different trajectories without accurately performing compression and tension behaviors up and down.

Accordingly, if the same spring pad is applied to both left and right sides of the suspension of the rear wheel, it is highly likely that either one of the left and right side dynamic seating property is insufficient, so it is difficult to satisfy both equally. In order to equally satisfy the left and right side dynamic seating property, the specifications of the spring pad for the left side and the spring pad for the right side must be separately specified, so there is a problem in that the cost increases.

Moreover, since durability is a more important performance in a spring pad, based on analysis of durability performance and the results of actual vehicle evaluation, the spring pad has no choice but to be designed in a direction satisfying the dynamic seating property.

In addition, the requirements of the spring pad to satisfy the durability during bump and at the same time to satisfy the dynamic seating property during rebound conflict with each other. A reason for this conflict is that less compression is required during bumps for durability, and the spring pad and spring must be maximally compressed during rebounding for the dynamic seating property.

As described above, the spring is assembled symmetrically with respect to the origin, and the problems arising from bumps and rebounds are different, and the requirements of the corresponding spring pads also conflict with each other, so the design of the spring pad is quite difficult.

Accordingly, the present disclosure intends to propose a structure of a spring pad that can obtain cost benefits by satisfying requirements for dynamic seating property and durability, and unification of specifications.

Hereinafter, the present disclosure is described in detail with reference to exemplary drawings. In adding reference numerals to components in each drawing, it should be noted that the same components are given the same reference numerals as possible even though they are indicated in different drawings.

In the present specification, the terms “left and right”, “rear”, “up and down”, “lower” and the like used in relation to the direction are defined based on a vehicle or a vehicle body on which a suspension is mounted.

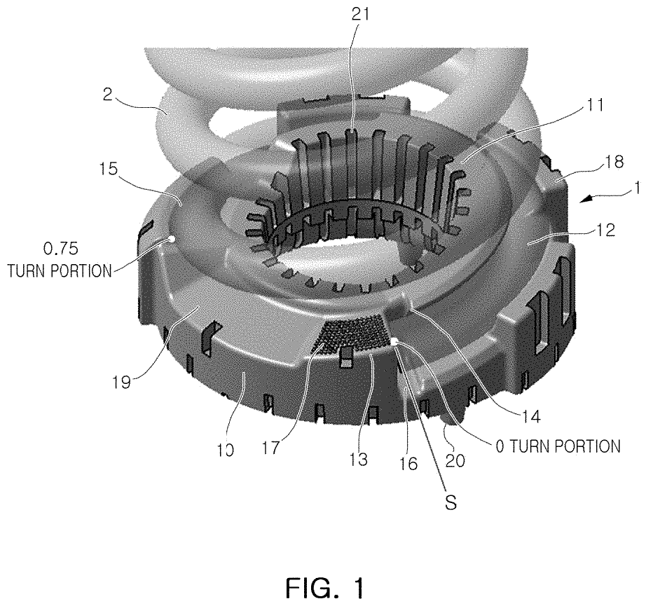

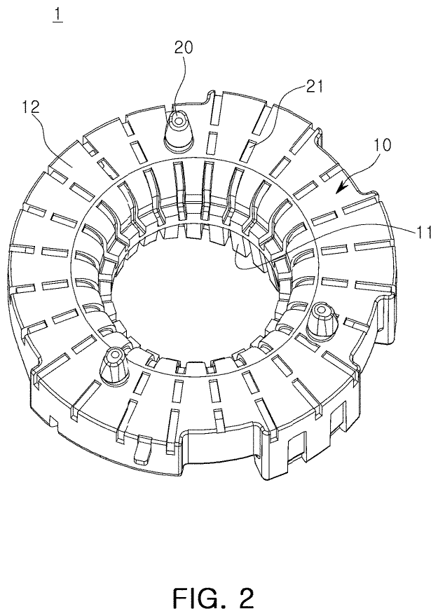

FIG. 1 is a perspective view illustrating a state in which a spring pad according to an embodiment of the present disclosure supports a spring, and FIG. 2 is a perspective view of the spring pad shown in FIG. 1 as viewed from below.

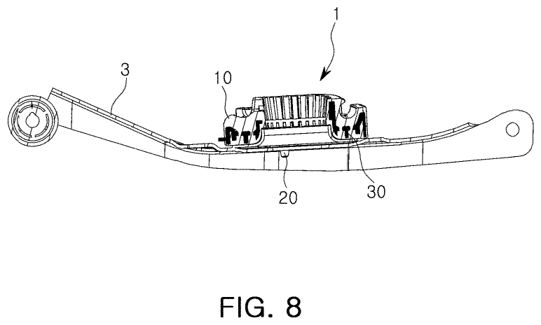

A spring pad 1 according to an embodiment of the present discourse may include a body portion 10 and an insert portion 30 (see. FIG. 8).

The body portion 10 may be made of an elastic material such as an elastomer such as rubber or synthetic resin, or a modified body of the elastomer. As the elastomer, for example, a thermoplastic elastomer exhibiting elasticity at room temperature and thermoplasticity at high temperature and which can be molded through a simple process may be employed.

In addition, the body portion 10 may include: an interposition portion 11 formed in a cylindrical shape, and inserted into a lower end portion of the spring 2; a seating portion 12 extending radially from one end portion of the interposition portion to seat the lower end portion of the spring; and a protruding step 13 formed in the seating portion on which one end of the spring is caught.

The interposition portion 11 may be formed in a substantially cylindrical shape having an outer diameter, equal to or smaller than an inner diameter of the spring so as to be inserted into the spring 2. This insert portion may entirely made of a cylindrical shape having a circular cross-section, and an extension portion 14 extending at least partially radially may be formed at an upper end thereof. In addition, a portion of the outer side surface of the insert portion may be connected to the protruding step 13.

The seating portion 12 may be formed in a substantially circular ring shape extending radially along a periphery of a lower end of the interposition portion 11, to support the lower end portion of the spring 2. An upper surface of the seating portion may include an inclined surface 15 formed to be inclined along the circumferential direction.

The inclined surface 15 may be formed, for example, in a region of an upper surface of the seating portion 12 corresponding from 0 turn portion to 0.75 turn portion of the spring 2, and may be formed in a substantially spiral shape such that a height may gradually increase toward the region from 0 turn portion to 0.75 turn portion.

As described above, since a lower end portion of the spring 2 is seated and a portion making substantial contact with the spring is formed as an inclined surface 15, the seating portion 12 may maintain a state in close contact with spring regardless of the behavior of the spring, thereby more effectively suppressing inflow of foreign substances.

The protruding step 13 may be formed to protrude from the seating portion 12 in a height direction, so that one end of the spring 2 is caught on one side surface of the protruding step in a circumferential direction. One side surface of the protruding step extending radially and facing in the circumferential direction may be connected to an outer side surface of the interposition portion 11.

The protruding step 13 is disposed to face one end of a wire constituting the spring 2 at a position at which the inclined surface 15 starts, to support one end of the spring. Accordingly, one side surface of the protruding step may act as a starting point S of the spring.

Here, when the spring 2 is manufactured by winding a straight metal wire in a coil shape, one end of the spring may not be bent in a curved shape due to a problem in processing, so a 0 turn portion of the spring is formed in a straight shape.

Although the one straight end is very short, a portion of edges the one straight end, in a process of coupling the spring 2 and the spring pad 1, and compression or tension of the spring, may cause damages to the spring pad and the body portion 10 by concentrating a load locally on a specific portion of the inclined surface 15.

In order to prevent this, at the position at which the inclined surface 15 starts, at the starting point S of the spring, a spare groove 16 extending radially of the seating portion 12 and opened radially outwardly may be formed.

In addition, an embossed portion 17 treated with unevenness may be formed on an upper surface of the protruding step 13. The embossed portion 17 may increase frictional force while increasing a contact area with the spring 2 to prevent the spring from sliding, and act as a buffer, so that the embossed portion may prevent damages to the spring pad 1 and the spring 2 due to impacts.

The body portion 10 may further include at least one support portion 18 formed radially outwardly of the seating portion 12 to support an outer surface of the lower end portion of the spring 2. When a plurality of support portions are formed, the plurality of support portions may be disposed to be spaced apart from each other by a predetermined distance in a circumferential direction of the seating portion.

Together with an extension portion 14 of the interposition portion 11, the support portion 17 of the seating portion 12 may maintain a position of a lowermost wire of the spring 2 fixed without being separated from the seating portion.

In addition, the body portion 10 may further include a discharge unit 19 formed between an uppermost end of the inclined surface 15 and the protruding step 13 for discharging foreign substances.

Among upper surfaces of the seating portion 12, a remaining portion except for the inclined surface 15 is not substantially contact with the spring 2. The discharge unit 19 may be disposed to prevent foreign substances from accumulating in such a portion. The discharge unit may be formed so that a radially inner side is higher than a radially outer side and inclined downwardly toward the radially outer side.

One or more fixing protrusions 20 to be attached to a support member such as a lower arm 3 (refer to FIG. 8), for example, may be formed by protruding downwardly on a bottom surface of the spring pad 1, that is, a bottom surface of the body portion 10. The fixing protrusion may be integrally molded on the bottom surface of the body portion, or assembled after being separately formed.

In addition, in the body portion 10, a plurality of support grooves 21 may be formed along a height direction on an outer peripheral surface of the seating portion 12 and an inner peripheral surface of the interposition portion. And, a plurality of support grooves 21 extending radially on the bottom surface of the body portion 10 can be formed. Optionally, the support groove formed on the inner circumferential surface of the interposition portion and the support groove formed on the bottom surface of the body portion may be connected to each other.

The support groove 21 may be formed so that the insert portion 30 is not separated from a mold and is fixed during molding of the spring pad 1.

Meanwhile, in order to form the spring pad 1 satisfying both the conflicting dynamic seating property and durability, in the present disclosure, it is characterized in that a separate composite line, different from a spiral of the spring 2 is reflected in a spiral curve for forming the inclined surface 15 of the seating portion 12.

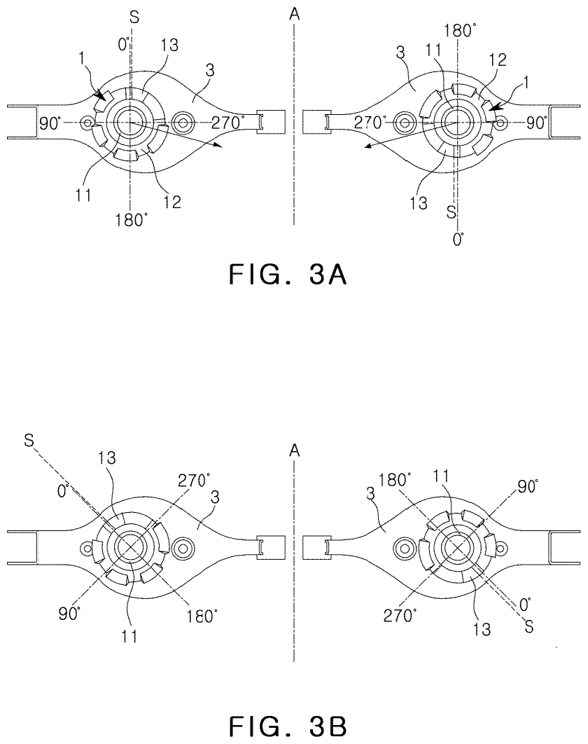

FIGS. 3A and 3B are views for illustrating setting of a starting point of a spring in a spring pad.

As illustrated in FIG. 3A, in order for a spring load to be symmetrically input to both side suspensions, right and left side suspensions with respect to a longitudinal axis (A) of a vehicle, a starting point S of the spring should be positioned symmetrically to an origin on both sides of the spring pad 1.

On both left and right sides of the suspension, the lower arm 3 on which the spring 2 is mounted is formed symmetrically, whereas the starting point S of the spring is located symmetrically to the origin, so a gap between the spring 2 and the spring pad 1 on both sides during rebounding may not be the same on the left and right side.

In addition, during rebounding, the dynamic seating property should be satisfied at least in a section from the starting point S of the spring on the spring pad 1, that is, from 0° to 270° (from 0 turn portion to 0.75 turn portion based on the spring). This section may be determined by a winding shape of the spring 2.

Accordingly, the present disclosure analytically confirms a gap between the spring pad and the spring on both left and right sides during rebounding, while changing the starting point S of the spring. For example, a position of the starting point was changed by 45° in a counterclockwise direction of the drawing from the starting point position of FIG. 3A, and behavior of the spring and the gap between the spring pad and the spring were examined at each changed starting point position.

In terms of the behavior of the spring, depending on a geometry of the suspension, the lower arm, or the like, an assembly position, posture of the spring, and the like, the spring does not compress and tension exactly up and down, but behaves in different trajectories on both sides left and right side of a suspension. This behavior is the same even if the position of the starting point is changed.

For example, when a starting point position of FIG. 3A is 0°, a left spring of the left suspension moves toward an azimuth of about 255° like an arrow in a winding direction (e.g., counterclockwise) from the starting point, and when a starting point position of FIG. 3A is 0°, a right spring of the right suspension moves toward an azimuth of about 285° like an arrow in a winding direction (e.g., counterclockwise) from the starting point. In this case, a 0.75 turn portion of the right spring cannot be seated on the spring pad.

Considering this behavior of the right spring, it means that the starting point of the spring on the spring pad must be at a position rotated counterclockwise by at least 30° from the starting point shown in FIG. 3A so that the 0.75 turn portion of the spring can be sufficiently seated on the spring pad.

Considering the gap between the spring pad and the spring, it could be confirmed analytically that the gap between the spring pad and the spring is reduced compared to the starting point position of FIG. 3A, when moved by 45° in a counterclockwise direction of the drawing from the starting point position of FIG. 3A.

In particular, when a position of the starting point is moved by about 45°, it can be seen that the gap between a portion within a 0.55 turn portion of the spring and the spring pad is significantly reduced, and within 0.7 turn portion after the 0.55 turn portion of the spring, the spring is seated on the spring pad without a gap.

Accordingly, in the spring pad according to an embodiment of the present disclosure, as illustrated in FIG. 3B, one side surface of the protruding step 13, acting as the starting point S of the spring, is moved in a counterclockwise direction of the drawing by 30 to 45° with respect to a longitudinal axis (A) of the vehicle to be mounted on the lower arm 3.

When the starting point S of the spring is moved to less than 30°, there may be a disadvantage in that a turn portion of the spring 2, not seated on the spring pad 1, increases, and when the starting point S of the spring moves by an amount exceeding 45°, the gap with the spring pad is excessively widened after the 0.55 turn portion of the spring, and there may be a concern in that durability of the spring pad is deteriorated during bumping.

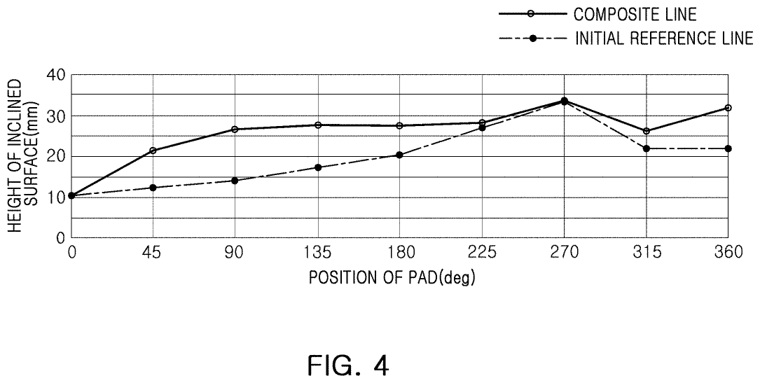

FIG. 4 is a graph for illustrating a composite line reflected in a spring pad according to an embodiment of the present disclosure.

Basically, an “initial reference line” in which a spiral curve corresponding to a spiral of a lower end portion of the spring 2 is shown on a plane to form an inclined surface 15 of the spring pad 1 is known. Such a reference line is indicated by a dashed-dotted line in a graph of FIG. 4.

In addition, the present disclosure analytically obtains a line regarding a gap between a spring and a spring pad having an inclined surface of an initial reference line during rebound when a starting point S of the spring is moved by about 45°. Because a gap between a left spring and the spring pad and a gap between a right spring and the spring pad are still different from each other during rebound, a left gap line of the left spring and a right gap line of the right spring, which are separate from each other, are obtained.

The present disclosure pays attention to the fact that, if an elastic material is further supplemented to fill the gap in the spring pad for a portion lacking in dynamic seating property, dynamic seating property may be improved, for example, even in full rebound.

In one embodiment, the left gap line and the right gap line may be combined together with the initial reference line, and then, a maximum value of the gap at each azimuth in a winding direction of the spring from the starting point may be indicated, and the maximum value may be connected so that a predetermined initial composite line may be obtained.

For example, an approximately 0° to 45° section of the initial composite line may use an initial reference line, an approximately 30° to 180° section of the initial composite line may use a right gap line, and an approximately 1800 to 255° section of the initial composite line may use a left gap line.

Here, the section using the initial reference line means a section in which the left spring and the right spring are seated without a gap for each spring pad.

The spring pad having an inclined surface of the initial composite line obtained in this manner was modeled, and a line regarding the gap between this spring pad and each spring during rebounding was again analytically obtained. In this case, the obtained initial composite line acts as a new reference line.

When there is a gap between the left spring and the spring pad or a gap between the right spring and the spring pad during rebounding, a process in which the left gap line and the right gap line are combined together with the obtained initial composite line, that is, a new reference line, and a maximum value of the gap thereof is connected thereto, is repeated. Thereby, a predetermined composite line can be obtained.

The spring pad having an inclined surface of the composite line obtained in this manner was modeled, and whenever there is a gap between the left spring and the spring pad and a gap between the right spring and the spring pad during rebounding, a line for the gap between the spring pad and each spring was analytically obtained again. The subsequently obtained composite line serves as a new reference line.

By repeating a process of combining the left gap line and the right gap line together with the reference line, and connecting a gap maximum value thereof, a “composite line” in which the gap between the inclined surface 15 of the spring pad 1 and the spring 2 is eliminated or minimized simultaneously in the left and right suspensions, may be obtained. Such a composite line is indicated by a solid line in the graph of FIG. 4.

For example, the inclined surface according to the initial reference line illustrates that a slope gradually increases with an almost constant slope from the starting point (0°) to 180°, and a slope increases more rapidly from 180° to 270°, than before.

On the other hand, the inclined surface 15 according to the composite line may illustrate that a slope rapidly increases from the starting point (0°) to 90° and more gently increases from 90° to 225° than before, which is almost horizontal. Thereafter, from 225° to 279°, it may have a similar slope to the slope according to the initial reference line.

As described above, in the spring pad 1 according to an embodiment of the present disclosure, as illustrated in FIG. 4, a composite line, generally set higher than the initial reference line of a spiral curve corresponding to the spiral of a lower end portion of the spring in the prior art for dynamic seating property, may be reflected to the spiral curve, such that an inclined surface 15 of the seating portion 12 may be formed. In other words, the seating portion of the spring pad according to an embodiment of the present disclosure may have an overall larger dimension in a height direction than that of the prior art.

In one embodiment, the spring pad 1 may be equally applied to both suspensions regardless of the specification of the left suspension and the specification of the right suspension to support the spring 2, and a lower end portion of the spring is closely seated on the inclined surface 15 formed in the seating portion 12, thereby obtaining an effect of improving the dynamic seating property.

The body portion 10 formed of only an elastic material has insufficient rigidity to counteract force transmitted by vibration or impact, and thus durability performance may be deteriorated. For example, an input load of the spring pad 1 during bumping is reaction force of the spring 2, but only the body portion made of an elastic material cannot withstand such reaction force.

In order to satisfy this durability, the insert portion 30 made of metal or plastic may be embedded inside the body portion 10 to complete a spring pad 1 having durability.

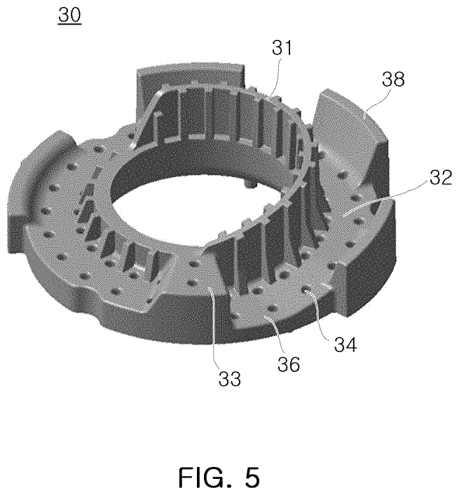

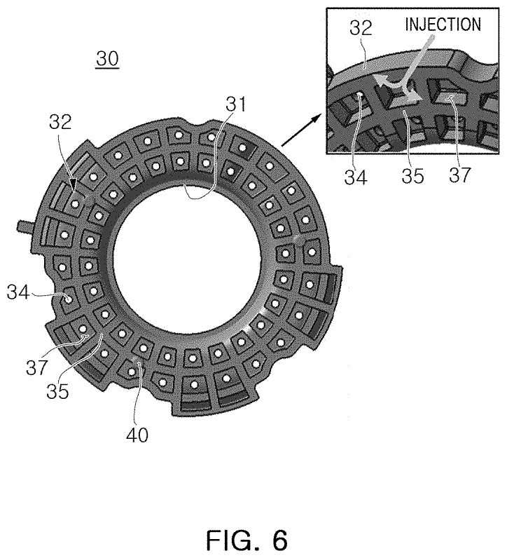

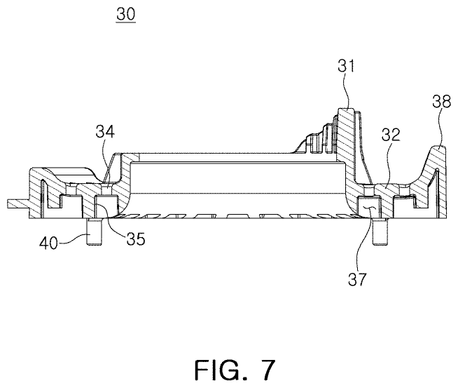

FIG. 5 is a perspective view illustrating an insert portion inserted into the spring pad shown in FIG. 1. FIG. 6 is a bottom view of the insert portion shown in FIG. 5, and FIG. 7 is a cross-sectional view of the insert portion shown in FIG. 5.

The insert portion 30 may be made of a hard material such as metal such as steel, plastic, glass fiber, or plastic containing ceramic. In one embodiment, the insert portion is made of plastic and thus rust is not formed even when moisture flows into the spring pad 1, so that a service life can be extended compared to the insert portion made of steel.

As the plastic, for example, one or more of polypropylene, polyoxymethylene, and polyamide may be employed.

In addition, the insert portion 30 may include an insert interposition portion 31 embedded in the interposition portion 11; an insert seating portion 32 extending radially from one end portion of the insert interposition portion and embedded inside the seating portion 12; and an insert protruding step 33 formed in the insert seating portion and embedded inside the protruding step 13.

An upper surface of the insert seating portion 32 may include an inclined surface formed to be inclined in a circumferential direction. However, the present disclosure is not limited thereto, and the upper surface thereof may be formed as an approximately horizontal surface.

In addition, the upper surface of the insert seating portion 32 may include a concave portion 36 formed to be recessed in response to a portion in which a thickness of an elastic material layer is reduced in the body portion 10, thereby providing a desired thickness of the elastic material layer and capable of inhibiting or preventing damages to the body portion caused by an input load of the spring 2.

In the insert seating portion 32, for example, a recessed portion 36 may be formed in a portion corresponding to a spare groove 16 of the body portion 10, and the insert seating portion in the concave portion may have a reduced thickness.

In addition, the insert portion 30 may further include at least one insert support portion 38 formed radially externally of the insert seating portion 32 and embedded in the support portion 18. When the support portion is formed in plural, the insert support portion is also formed in plural, and the plurality of insert support portions may be disposed apart from each other at a predetermined distance along a circumferential direction of the insert seating portion.

When a fixing protrusion 20 is integrally formed on a bottom surface of the body portion 10, an insert protrusion 40 protruding from an opposite side of the insert interposition portion 31 in the insert seating portion 32 to be embedded inside the fixing protrusion may be formed. The insert protrusion may be fitted and coupled to a support member such as a lower arm 3 (refer to FIG. 8) together with the fixing protrusion.

The insert portion 30 may be integrally formed by insert injecting into the body portion 10 made of an elastic material, thereby completing the spring pad 1 including the body portion and the insert portion. More specifically, after mounting the separately manufactured insert portion inside a mold, by injecting an elastic material into a space in the mold provided for injection of the body portion, the body portion in which the insert portion is immersed may be molded.

In this case, when the body portion 10 is injected, an insert fixing member (not shown) for fixing the insert portion 30 may be provided inside a mold, and traces of the insert fixing member after forming may remain as support grooves 21 of the body portion.

For insert injection, a plurality of through-holes 34 may be formed in the insert seating portion 32. These through-holes may be uniformly arranged and formed at equal intervals along a circumferential direction in a plurality of rows radially in and out of the substantially ring-shaped insert seating portion.

By increasing a contact area at which the insert portion 30 and the body portion 10 are coupled through the plurality of through-holes 34, it is possible to improve coupling force therebetwen.

As described above, the body portion 10 of the spring pad 1 according to an embodiment of the present disclosure may form an inclined surface 15 by reflecting a composite line to improve dynamic seating property, so that a thickness of the elastic material may increase substantially. Accordingly, the dynamic seating property during full rebound can be improved.

However, when a thickness of the elastic material increases, there is a risk that durability performance may be reduced despite the presence of the insert portion 30, and if the elastic material is excessively added, the spring 2 may be separated from the spring pad 1 at full rebound.

In one embodiment, in the insert portion 30 of the spring pad 1, an upper surface of the insert seating portion 32 may be formed as a flat surface, and an opposite side of the insert interposition portion 31, that is, a bottom surface thereof may include a rib 35 formed to surround the through-hole 34.

Accordingly, a plurality of groove portions 37 may be formed on the bottom surface of the insert interposition portion 31 by the ribs 35 surrounding the through-hole 34.

Due to this configuration, the insert portion 30 may surface-support the spring 2 by a flat surface on an upper surface of the insert seating portion 32 without affecting injection of the elastic material through a plurality of through-holes 34 when the spring pad 1 is formed, such that an input load may be distributed. By significantly increasing a contact area with the elastic material by the rib on a bottom surface of the insert seating portion, coupling force between the insert portion 30 and the body portion 10 can be further improved.

Therefore, the spring pad 1 according to an embodiment of the present disclosure may reduce stress by the flat surface on the upper surface of the insert seating portion 32, even though a thickness of the elastic material is increased to improve dynamic seating property, and damage to the body portion 10 made of the elastic material may be inhibited or prevented, thereby improving durability.

As described above, according to an embodiment of the present disclosure, the spring pad satisfies all conflicting dynamic seating property and durability, and unification of specifications, thereby reducing costs and extending service life.

FIG. 8 is a cross-sectional view illustrating an example in which a spring pad according to an embodiment of the present disclosure is applied to a lower arm. In particular, FIG. 8 illustrates a state in which the spring pad 1 is installed in the lower arm 3 constituting a suspension.

As illustrated in FIG. 8, an insert portion 30 made of a hard material (refer to solid hatching) is embedded in a body portion 10 made of an elastic material, and the spring pad 1 is integrally formed.

In addition, an insert protrusion 40 of the insert portion 30 is fitted into a coupling hole (not shown) of the lower arm 3 together with a fixing protrusion 20 of the body portion 10, such that the spring pad 1 may be coupled to the lower arm 3.

As described above, the spring pad 1 may be disposed and mounted on the lower arm 3 so that a surface on one side of the protruding step 13 acting as a starting point S of the spring is moved by about 30 to 45° with respect to a longitudinal axis A of a vehicle.

As described above, the spring pad 1 according to an embodiment of the present disclosure may be coupled to the lower arm 3, so that the spring pad may support a spring 2 and avoid direct contact between metal and metal between the lower arm and the spring, and seating property of the spring may be ensured.

When the spring pad according to an example embodiment of the present disclosure is applied to the suspension, by mitigating vibrations or impacts received from a road surface and transmitting the same to the vehicle body, ride comfort and steering stability may be improved, and NVH reduction performance of the vehicle may also be improved, thereby increasing marketability of the vehicle.

While the example embodiments have been illustrated and described above, it should be apparent to those of having ordinary skill in the art that modifications and variations could be made without departing from the scope of the present disclosure.

What is claimed is:

1. A spring pad comprising:
a body portion disposed on one side of a spring and configured to support the spring; and
an insert portion embedded inside of the body portion and integrally formed with the body portion,
wherein the spring is seated on an inclined surface of the body portion, and the inclined surface is formed in a spiral shape gradually increasing in height, and
wherein a spiral curve of the inclined surface is formed by reflecting a composite line minimizing a gap between the inclined surface and the spring.

2. The spring pad of claim 1, wherein the body portion is formed of an elastic material,
wherein the body portion comprises,
an interposition portion formed in a cylindrical shape to be inserted into the spring;
a seating portion extending radially from one end portion of the interposition portion and on which the spring is seated; and
a protruding step formed in the seating portion and to which one end of the spring is caught.

3. The spring pad of claim 2, wherein the protruding step is formed to protrude in a height direction from the seating portion, and one side surface of the protruding step in a circumferential direction to which one end of the spring is caught act as a starting point of the spring.

4. The spring pad of claim 3, wherein the inclined surface is formed up to a section up to 270° in a winding direction of the spring with the starting point of the spring as 0°.

5. The spring pad of claim 3, wherein, when the spring pad is mounted on a suspension of a vehicle, the starting point of the spring is mounted by being moved by 30 to 45° with respect to a longitudinal axis of the vehicle.

6. The spring pad of claim 3, wherein the composite line is obtained by combining a reference line, a left-side gap line regarding a gap between a spring pad having an inclined surface reflecting the reference line and a spring in a left-side suspension of a vehicle, and a right-side gap line regarding a gap between a spring pad having an inclined surface reflecting the reference line and a spring in a right-side suspension of a vehicle, and connecting a maximum value of the gap at each azimuth in a winding direction of the spring from the starting point of the spring.

7. The spring pad of claim 6, wherein the reference line comprises an initial reference line corresponding to a spiral of a lower end portion of the spring.

8. The spring pad of claim 2, wherein the insert portion is formed of a hard material,
wherein the insert portion comprises,
an insert interposition portion embedded inside of the interposition portion;
an insert seating portion extending radially from one end portion of the insert interposition portion and embedded inside of the seating portion; and
an insert protruding step formed in the insert seating portion and embedded inside of the protruding step.

9. The spring pad of claim 8, wherein an upper surface of the insert seating portion comprises a concave portion formed to be recessed corresponding to a portion in which a thickness of an elastic material layer in the body portion is reduced.

10. The spring pad of claim 8, wherein a plurality of through-holes arranged in a circumferential direction are formed in the insert seating portion,
a flat surface is formed on an upper surface of the insert seating portion and configured to surface-support the spring, and
a groove portion is formed by a rib surrounding each through-hole of the plurality of through-holes on an opposite side surface of the spring in the insert seating portion.

11. A spring pad comprising:
a body portion disposed on one side of a spring and configured to support the spring; and
an insert portion embedded inside of the body portion and integrally formed with the body portion,
wherein a plurality of through-holes arranged in a circumferential direction are formed in the insert portion,
a flat surface is formed on one side surface of the insert portion and configured to surface-support the spring, and
a groove portion is formed by a rib surrounding each through-hole of the plurality of through-holes on an opposite side of the spring in the insert portion.

12. The spring pad of claim 11, wherein the body portion is formed of an elastic material, and the insert portion is formed of a hard material,
wherein the insert portion comprises:
an insert interposition portion embedded inside of an interposition portion inserted into the spring from the body portion;
an insert seating portion extending radially from one end portion of the insert interposition portion; and
an insert protruding step formed in the insert seating portion,
wherein the plurality of through-holes are formed in the insert seating portion.

13. The spring pad of claim 12, wherein an upper surface of the insert seating portion comprises a concave portion formed to be recessed corresponding to a portion in which a thickness of an elastic material layer in the body portion is reduced.
